(19) United States
(12) Patent Application Publication
(10) Pub. No.: US 2026/0198658 A1
(43) Pub. Date: Jul. 16, 2026

(54) WRIST-WORN ELECTRONIC DEVICE AND WEARABLE DEVICE

(71) Applicant: HUAWEI TECHNOLOGIES CO., LTD., Shenzhen, Guangdong (CN)

(72) Inventors: Yu GUO, Xi’an (CN); Chao XUE, Xi’an (CN); Xu ZHANG, Xi’an (CN); Ziyi WANG, Xi’an (CN)

(21) Appl. No.: 18/866,148

(22) PCT Filed: May 12, 2023
(86) PCT No.: PCT/CN2023/093977

§ 371 Date: Nov. 15, 2024

(30) Foreign Application Priority Data
May 16, 2022 (CN) 202221173845.7

(51) Int. Cl. A44C 5/14; G04G 17/08

(52) U.S. Cl. CPC A44C 5/145; A44C 5/147; G04G 17/08

(57) ABSTRACT

An example wrist-worn electronic device includes a body and a wrist strap, and the body includes a middle frame, a rear cover, a latch, and a button. The rear cover covers, along a first direction, the middle frame. The rear cover includes a first through hole extending along the first direction, which connects with an inner cavity of the middle frame. The latch is disposed in the inner cavity of the middle frame, and can move, between a first position and a second position. When the latch is located in the first position, the wrist strap can be latched to the body, or when the latch is located in the second position, the wrist strap can be released from the body. The button is used to provide, when being pressed, the latch with a push force for moving from the first position to the second position.

This application claims priority to Chinese Patent Application No. 202221173845.7, filed with the China National Intellectual Property Administration on May 16, 2022 and entitled “WRIST-WORN ELECTRONIC DEVICE AND WEARABLE DEVICE”, which is incorporated herein by reference in its entirety.

### TECHNICAL FIELD

This application relates to the field of wearable device technologies, and in particular, to a wrist-worn electronic device and a wearable device.

### BACKGROUND

With explosive growth of intelligent wearable devices, people put forward higher requirements on aesthetics and convenience of the intelligent wearable devices. A smartwatch is used as an example. A user expects that a watch strap of the smartwatch can be more conveniently removed/replaced, and expects that the smartwatch has a more delicate appearance.

However, for some smartwatches, as a result of a structure design of a quick disassemble mechanism, when a user removes a wrist strap, a problem that a structure is stuck or an operation is inflexible may occur. In addition, there is a relatively large assembling error between a button of the quick disassemble mechanism and a rear cover of a device. This affects appearance aesthetics of the device.

### SUMMARY

Some implementations of this application provide a wrist-worn electronic device and a wearable device. The following describes this application from a plurality of aspects. For implementations and beneficial effects of the following plurality of aspects, refer to each other.

According to a first aspect, an implementation of this application provides a wrist-worn electronic device. The wrist-worn electronic device includes a body and a wrist strap, and the body includes a middle frame, a rear cover, a latch, and a button that are independent of each other in structure, where an inner cavity is formed in the middle frame; the rear cover covers, along a first direction, the middle frame, the rear cover includes a first through hole extending along the first direction, and the first through hole communicates with the inner cavity of the middle frame; the latch is disposed in the inner cavity of the middle frame, and can move, along the first direction relative to the middle frame, between a first position and a second position, where when the latch is located in the first position, the wrist strap can be latched to the body, or when the latch is located in the second position, the wrist strap can be released from the body; and the button extends through the first through hole and abuts, along the first direction, against the latch, where the button is used to provide, when being pressed, the latch with a push force for moving from the first position to the second position.

According to an implementation of this application, the middle frame, the rear cover, the latch, and the button are components that are independent of each other in structure. Therefore, in an assembling process of the electronic device, the button may be pre-assembled on the rear cover. In this way, precision of alignment between the rear cover and the first through hole is not affected by installation errors of the middle frame and the latch, and is not affected by a processing error that is of the through hole and that is on the rear cover, so that precision of alignment between the button and the through hole can be ensured. In other words, according to a solution provided in this application, there may be a uniform gap between the button and the rear cover, to ensure appearance aesthetics of the electronic device. In addition, the button does not scratch the rear cover in a process of being pressed, so that convenience of an operation of removing the wrist strap and long-term reliability of the electronic device can be improved.

In some implementations, an elastic material is disposed on an abutting surface that is of the button and that abuts against the latch, and/or an elastic material is disposed on an abutting surface that is of the latch and that abuts against the button.

In some implementations, a groove is provided on the abutting surface that is of the button and that abuts against the latch, and/or a groove is provided on the abutting surface that is of the latch and that abuts against the button, an elastic material is disposed in the groove, and the elastic material is used to fill, in the first direction, a gap between the button and the latch.

In some implementations, the button includes a button body and a shoulder that are connected along the first direction, the button body is located in the first through hole, the shoulder is located in the inner cavity, and a size of a cross section of the shoulder is greater than a size of a cross section of the first through hole.

In some implementations, when the button is not pressed, an outer surface of the button is flush with an outer surface of the rear cover.

In some implementations, at least a part of the button is made of a magnetic material.

In some implementations, the latch and the middle frame are connected by using an elastic element, and the elastic element is used to provide the latch with a recovery force for returning from the second position to the first position.

In some implementations, along the first direction, the elastic element is located on a side that is of the latch and that faces away from the button.

In some implementations, when the latch is in the first position, the elastic element has a first compression amount, or when the latch is in the second position, the elastic element has a second compression amount, where the second compression amount is greater than the first compression amount.

In some implementations, the elastic element is a spring, and the latch includes a guide post sleeved in the spring.

In some implementations, the middle frame includes a limiting part, and the limiting part is used to limit a limit movement position of an end of the latch in the first direction to the first position.

In some implementations, the latch includes a second through hole extending along a second direction, and the second direction is perpendicular to the first direction; and the wrist strap includes a latch hook, where when the latch is located in the first position, the latch hook can pass through the second through hole and be hooked, along the second direction, with the latch, to latch the wrist strap to the body, or when the latch is located in the second position, the latch hook can be detached from the second through hole, to release the wrist strap from the body.

In some implementations, the middle frame includes a third through hole extending along the second direction, and the latch hook can pass through the third through hole to be hooked with the latch; the wrist strap further includes a stopper connected to the latch hook, and the stopper is on an outer side of the middle frame; and when the latch hook is hooked with the latch, the stopper and the middle frame abut, along the second direction, against each other, where an elastic material is disposed on an abutting surface that is of the stopper and that abuts against the middle frame, and/or an elastic material is disposed on an abutting surface that is of the middle frame and that abuts against the stopper.

In some implementations, a clamping slot is disposed on one of the middle frame and the rear cover, a clamping block is disposed on the other one of the middle frame and the rear cover, and along the first direction, the clamping block is clamped in the clamping slot, so that the rear cover covers, along the first direction, the middle frame.

According to a second aspect, an implementation of this application provides a wearable device. The wearable device includes a body and a strap, and the body includes a middle frame, a rear cover, a latch, and a button that are independent of each other in structure, where an inner cavity is formed in the middle frame; the rear cover covers, along a first direction, the middle frame, the rear cover includes a first through hole extending along the first direction, and the first through hole communicates with the inner cavity of the middle frame; the latch is disposed in the inner cavity of the middle frame, and can move, along the first direction relative to the middle frame, between a first position and a second position, where when the latch is located in the first position, at least one end of the strap can be latched to the body, or when the latch is located in the second position, at least one end of the strap can be released from the body; and the button extends through the first through hole and abuts, along the first direction, against the latch, where the button is used to provide, when being pressed, the latch with a push force for moving from the first position to the second position.

According to an implementation of this application, the middle frame, the rear cover, the latch, and the button are components that are independent of each other in structure. Therefore, in an assembling process of the wearable device, the button may be pre-assembled on the rear cover. In this way, precision of alignment between the rear cover and the first through hole is not affected by installation errors of the middle frame and the latch, and is not affected by a processing error that is of the through hole and that is on the rear cover, so that precision of alignment between the button and the through hole can be ensured. In other words, according to a solution provided in this application, there may be a uniform gap between the button and the rear cover, to ensure appearance aesthetics of the wearable device. In addition, the button does not scratch the rear cover in a process of being pressed, so that convenience of an operation of removing the wrist strap and long-term reliability of the wearable device can be improved.

### BRIEF DESCRIPTION OF DRAWINGS

FIG. 1 is a diagram of a structure of a wrist-worn electronic device (in a state in which a wrist strap is installed) according to an embodiment of this application;

FIG. 2 is a diagram of a structure of a wrist-worn electronic device (in a state in which a wrist strap is removed) according to an embodiment of this application;

FIG. 3 is a sectional view of the wrist-worn electronic device shown in FIG. 1 along a line A-A;

FIG. 4 is an enlarged view of a part B of the wrist-worn electronic device shown in FIG. 3;

FIG. 5 is a diagram of a structure of a wrist-worn electronic device according to some embodiments;

FIG. 6 is a C-direction view (a partial view) of the wrist-worn electronic device shown in FIG. 5;

FIG. 7 is a sectional view of the wrist-worn electronic device shown in FIG. 4; and

FIG. 8 is a diagram of a structure of a wearable device according to an embodiment of this application.

### DESCRIPTION OF EMBODIMENTS

The following describes specific implementations of this application in detail with reference to accompanying drawings.

An implementation of this application is used to provide a wrist-worn electronic device, to improve convenience of an operation of removing a wrist strap and appearance aesthetics of the electronic device. The wrist-worn electronic device (an “electronic device” for short) may be a smartwatch, a smart band, a wrist-worn physical sign (for example, a heart rate and blood oxygen) monitoring device, or the like. The following describes an example in which a smart band is used as the electronic device.

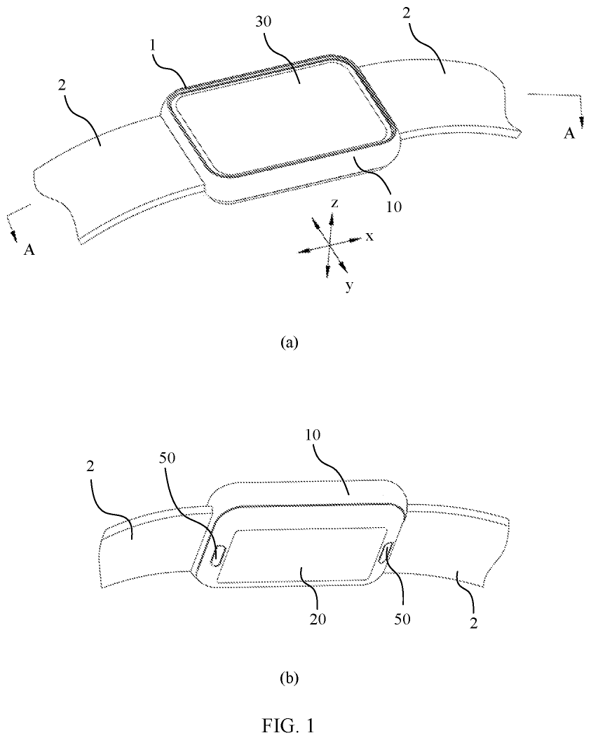

FIG. 1 is a diagram of a structure of an electronic device according to this embodiment. FIG. 1(a) shows a front side of the electronic device, and FIG. 1(b) shows a rear side of the electronic device. In the figures in this specification, an x direction is a length direction (as a second direction) of the electronic device, a y direction is a width direction of the electronic device, and a z direction is a thickness direction (as a first direction) of the electronic device. The x direction, y direction, and z direction are perpendicular to each other.

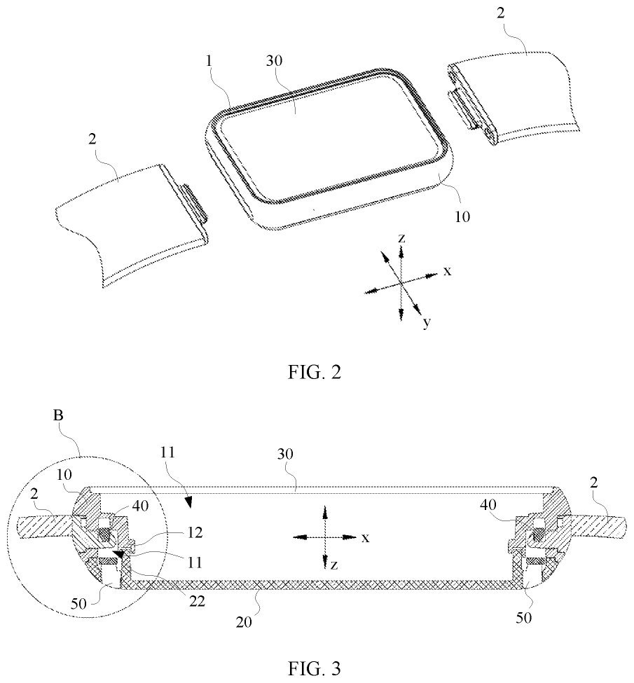

Refer to FIG. 1 and FIG. 2. The electronic device includes a body 1 and a wrist strap 2. The body 1 is a core functional component of the electronic device, and electronic components such as a processor, a sensor, an audio component, a communication component, and a power supply may be disposed inside the body 1. The wrist strap 2 is used for a user to wear the body 1 on a wrist.

The wrist strap 2 is connected to the body 1 in a removable manner. In this way, the user can perform replacement, cleaning, and the like on the wrist strap 2. FIG. 1 shows a state in which the wrist strap 2 is connected (or referred to as “latched”) to the body 1, and FIG. 2 shows a state in which the wrist strap 2 is removed (or referred to as “released”) from the body 1. In this embodiment, refer to FIG. 1(b). The user may remove the wrist strap 2 from the body 1 by pressing a button 50 on a rear side of the electronic device. When the user presses the button 50 on a left side, the wrist strap 2 on the left side may be removed. When the user presses the button 50 on a right side, the wrist strap 2 on the right side may be removed.

An example structure of the body 1 of the electronic device is described with reference to FIG. 3. FIG. 3 is a sectional view of FIG. 1(a) along A-A. Refer to FIG. 3. The body 1 includes a middle frame 10, a rear cover 20, a display 30, a latch 40, and the button 50.

An inner cavity 11 is formed in the middle frame 10, and an electronic component (for example, the processor or the power supply) of the electronic device may be disposed in the inner cavity 11. The rear cover 20 covers, along the z direction, the middle frame 10, to protect the electronic component in the inner cavity 11. In this embodiment, the middle frame 10 and the rear cover 20 are connected to each other by using a clamping slot 12 and a clamping block 22. Specifically, the clamping slot 12 is disposed on the middle frame 10, and the clamping block 22 is disposed on the rear cover 20. Along the z direction, the clamping block 22 is clamped in the clamping slot 12, so that the rear cover 20 securely covers the middle frame 10. In addition, along the z direction, the middle frame 10 and the rear cover 20 may be aligned with each other through fitting between the clamping slot 12 and the clamping block 22. In another embodiment, the clamping slot 12 may be provided on the rear cover 20, and the clamping block 22 may be disposed on the middle frame 10.

In this embodiment, the clamping slot 12 and clamping block 22 are used as examples of connection structures between the middle frame 10 and the rear cover 20. This application is not limited thereto. In another embodiment, the middle frame 10 and the rear cover 20 may be connected in another manner, for example, bonding, riveting, tenon connection, or fastener connection.

The display 30 and the rear cover 20 are respectively located on two opposite sides of the middle frame 10. In other words, along the z direction, the display 30 and the rear cover 20 are disposed opposite to each other. After the user wears the electronic device on the wrist, the rear cover 20 is located on a side that is of the electronic device and that faces the wrist of the user, and the display 30 is located on a side that is of the electronic device and that faces away from the wrist of the user. In another embodiment, the electronic device may alternatively not include the display 30. In this embodiment, the electronic device may include a front cover disposed opposite to the rear cover 20. The front cover and the middle frame 10 may be an integrally connected structure, or may be structures independent of each other.

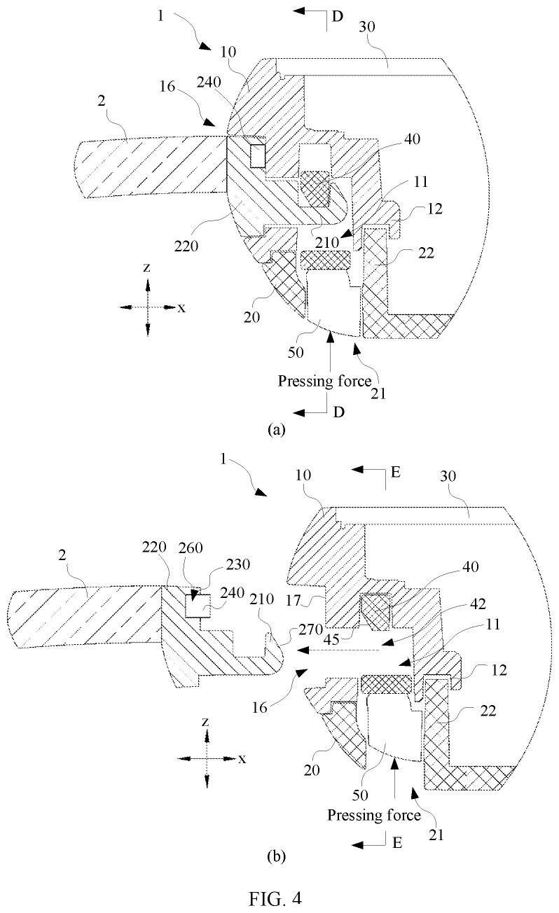

The latch 40 is disposed in the inner cavity 11 formed in the middle frame 10. The latch 40 is used to latch the wrist strap 2 to the body 1, or release the wrist strap 2 from the body 1. The following provides a description with reference to FIG. 4. FIG. 4(a) is an enlarged view of a part B of FIG. 3. FIG. 4(a) and FIG. 4(b) respectively show a state in which the latch 40 latches the wrist strap 2 and a state in which the latch 40 releases the wrist strap 2. Refer to FIG. 4. The latch 40 may move, along the z direction relative to the middle frame 10, between a first position and a second position. When the latch 40 is located in the first position (as shown in FIG. 4(a)), the wrist strap 2 may be latched to the body 1, or when the latch 40 is located in the second position (as shown in FIG. 4(b)), the wrist strap 2 may be released from the body 1. For continuity of the description, a specific manner in which the latch 40 latches or releases the wrist strap 2 is described below.

The button 50 is used to provide, when being pressed, the latch 40 with a push force for moving from the first position to the second position. Refer to FIG. 4. A through hole 21 (as a first through hole) is provided on the rear cover 20. The through hole 21 penetrates, along the z direction, the rear cover 20, and communicates with the inner cavity 11 formed in the middle frame 10. The button 50 extends through the through hole 21, and abuts, along the z direction, against the latch 40. In other words, along the z direction, the button 50 and the latch 40 are sequentially arranged, and the button 50 is closer to the rear cover 20 relative to the latch 40.

When the user presses the button 50, the button 50 moves along the z direction toward the latch 40, so that the latch 40 can be pushed from the first position to the second position. It may be understood that the first position is closer to the latch 40 relative to the second position.

In addition, in this embodiment, there are two sets of latches 40 and buttons 50. Refer to FIG. 3. Along the x direction, the two sets of latches 40 and buttons 50 are respectively located on a left side and a right side of the body 1. The latch 40 and button 50 on the left side is used for removing and installing of the wrist strap 2 on the left side, and the latch 40 and button 50 on the right side is used for removing and installing of the wrist strap 2 on the right side.

In this embodiment, the middle frame 10, the rear cover 20, the latch 40, and the button 50 are components that are independent of each other in structure. In this way, the middle frame 10, the rear cover 20, the latch 40, and the button 50 may be separately manufactured, and then assembled together. In this arrangement, flexibility of an operation of removing the wrist strap of the electronic device and an appearance aesthetic degree of the electronic device can be ensured. The following provides a description based on comparison with another embodiment.

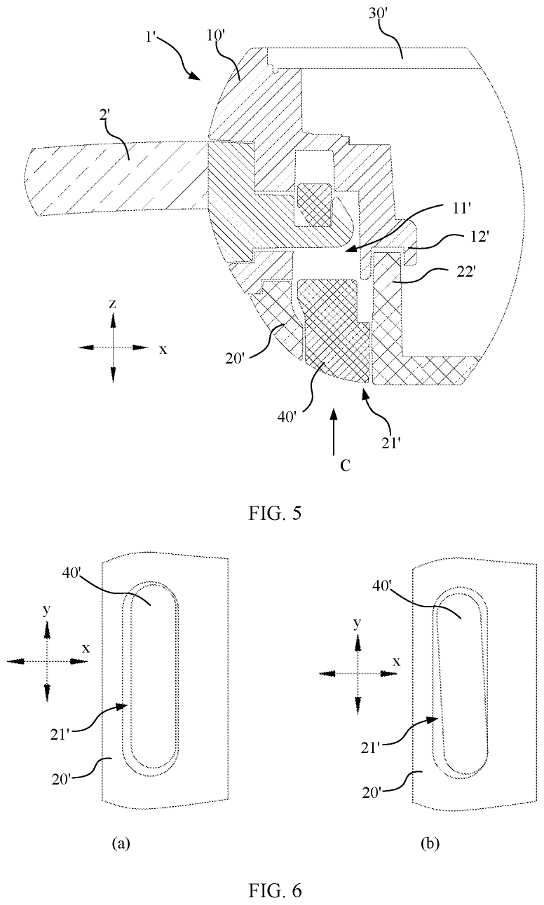

FIG. 5 shows an example structure of an electronic device according to some embodiments. Refer to FIG. 5. An electronic device includes a middle frame 10′, a rear cover 20′, and a latch 40′. A manner of disposing the middle frame 10′ and the rear cover 20′ is basically the same as the manner (for example, the manner shown in FIG. 4) provided in an embodiment of this application. To be specific, an inner cavity 11′ is formed in the middle frame 10′, and a through hole 21′ is provided on the rear cover 20. A difference is that, in this embodiment, the latch 40′ is an integrated mechanism. To be specific, the latch 40′ extends from the inner cavity 11′ of the middle frame 10′ to the through hole 21′ on the rear cover 20′. In this way, a user may push the latch 40′ from a first position to a second position by pressing a surface of the latch 40′.

In the electronic device shown in FIG. 5, the latch 40′ not only includes a part located in the inner cavity 11′, but also includes a part located in the through hole 21′. In this way, in an assembling process of the electronic device, it is difficult to accurately align the latch 40′ and the through hole 21′.

Specifically, the assembling process of the electronic device is as follows: The latch 40′ is first assembled on the middle frame 10′, and then the middle frame 10′ and the rear cover 20′ are assembled together. For different electronic devices, a position of the latch 40′ varies greatly. In addition, there are inevitably specific manufacturing/assembling errors at an installation position that is of the latch 40′ and that is on the middle frame 10′ and a processing position that is of the through hole 21′ and that is on the rear cover 20′. In this way, after the middle frame 10′ is aligned with the rear cover 20′ (for example, after the middle frame 10′ is aligned with the rear cover 20′ by using a clamping slot 12′ and a clamping block 22′), it is usually difficult to align the latch 40′ with the through hole 21′, and problems of low alignment precision and a large assembling error exist. The following provides a description with reference to FIG. 6.

FIG. 6 is a C-direction view (a partial view) of FIG. 5. Refer to FIG. 6(a). In some cases, the latch 40′ significantly deviates from a center of the through hole 21′. In other words, along a circumferential direction of the through hole 21′, a gap between the latch 40′ and the rear cover 20′ is not evenly distributed, and there is a relatively large step, which affects appearance aesthetics of the electronic device. Even in some other cases, refer to FIG. 6(b). The latch 40′ and the rear cover 20′ are in contact with each other and squeeze each other. In this case, the latch 40′ is stuck and difficult to be pressed; or the latch 40′ is difficult to reset, and the wrist strap 2′ falls off from the body 1′. In addition, in this case, the latch 40′ may be worn and damaged, and long-term reliability is poor.

However, in this embodiment, the middle frame 10, the rear cover 20, the latch 40, and the button 50 are components that are independent of each other in structure. Therefore, in the assembling process of the electronic device, the latch 40 may be first assembled on the middle frame 10 (an assembly completed in this step is referred to as a “middle frame assembly”), the button 50 may be assembled on the rear cover 20 (an assembly completed in this step is referred to as a “rear cover assembly”), and assembling of the middle frame assembly and the rear cover assembly is completed finally. Because the button 50 may be pre-assembled on the rear cover 20, precision of alignment between the rear cover 20 and the through hole 21 is not affected by installation errors of the middle frame 10 and the latch 40, and is not affected by a processing error that is of the through hole 21 and that is on the rear cover 20, so that precision of the alignment between the button 50 and the through hole 21 can be ensured (that is, the button 50 can be located at the center of the through hole 21). In this way, there may be a uniform gap between the button 50 and the rear cover 20, to ensure appearance aesthetics of the electronic device. In addition, the button 50 does not scratch the rear cover 20 in a process of being pressed, so that convenience of an operation of removing the wrist strap 2 and long-term reliability of the electronic device can be improved.

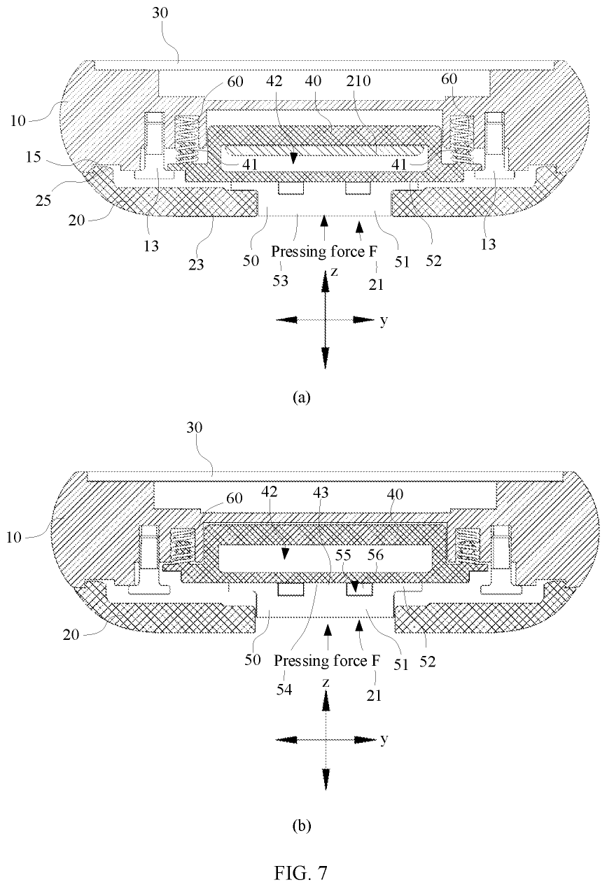

The following describes a specific disposing manner of the latch 40 and the button 50 provided in this embodiment with reference to FIG. 7. FIG. 7(a) is a sectional view of FIG. 4(a) along D-D (the latch 40 is located in the first position), and FIG. 7(b) is a sectional view of FIG. 4(b) along E-E (the latch 40 is located in the second position).

Refer to FIG. 7. The latch 40 and the middle frame 10 are connected by using an elastic element 60, and the elastic element 60 is used to provide the latch 40 with a recovery force for returning from the second position to the first position. Specifically, when the user presses the button 50, the latch 40 is pushed to the second position. In this case, the wrist strap 2 may be released from the body 1. When a pressing force of the user is released, the latch 40 may be automatically reset to the first position under an action of the elastic element 60.

In this embodiment, along the z direction, the elastic element 60 is located on a side that is of the latch 40 and that faces away from the button 50. In other words, when the latch 40 is pushed to the second position, the elastic element 60 is in a compressed state. When the push force acting on the latch 40 is released (for example, when the pressing force F of the user is released), the elastic element 60 deforms to an initial state, so that an elastic force (namely, a recovery force) in a direction toward the button 50 is generated on the latch 40, so that the latch 40 is reset to the first position.

Further, when the latch 40 is in the second position, the elastic element 60 has a second compression amount; or when the latch 40 is in the first position, the elastic element 60 has a first compression amount, where the second compression amount is greater than the first compression amount. In other words, in a process in which the latch 40 moves from the first position to the second position, the elastic element 60 is always in a compressed state, and a compression amount gradually increases. In this way, when the user starts to press the button 50, the user can sense a pressing resistance (the pressing resistance is provided by the elastic element 60). In other words, in a process of pressing the button 50, the user can always sense force feedback from the electronic device. This improves an operation feel.

In this embodiment, the elastic element 60 is specifically a spring, so that a structure of the electronic device can be simplified. Further, the latch 40 further includes a guide post 41 sleeved in the spring, to guide a moving process of the latch 40. However, this application is not limited thereto. In another embodiment, the elastic element 60 may alternatively be another elastic structure, for example, a spring plate or elastic rubber, provided that the elastic element 60 can provide the latch 40 with the recovery force.

Further, the middle frame 10 further includes a limiting part 13. As described above, the latch 40 may move along the z direction relative to the middle frame 10, and the limiting part 13 is used to limit a limit movement position of an end of the latch 40 to the first position. It may be understood that the “end” is an end that is on a moving stroke of the latch 40 and that faces the button 50. Disposing the limiting part 13 helps to stably keep the latch 40 in the first position. This helps to stably latch the wrist strap 2 to the body 1. In this embodiment, the middle frame 10 includes a threaded hole and a screw (there may be a quantity of screws and FIG. 7 shows two of the screws) that is screwed in the threaded hole, and the limiting part 13 is specifically a head of the screw. In addition, along the x direction and the y direction, the screw may further fasten the latch 40.

In another embodiment, the limiting part 13 may alternatively be another structure. For example, in another embodiment, the limiting part 13 is a steel sheet fastened to the middle frame 10. The steel sheet may be fastened to the middle frame 10 in a manner of bonding, hot melting, screw connection, or the like.

Still refer to FIG. 7. The button 50 includes a button body 51 and a shoulder 52 that are connected along the z direction, the button body 51 is located in the through hole 21, and the shoulder 52 is located in the inner cavity 11. A size of a cross section of the shoulder 52 is greater than a size of a cross section of the through hole 21. In this way, the button 50 can be prevented from falling off from the through hole 21. In this embodiment, a cross section is a section perpendicular to the z direction (namely, the thickness direction), and a size of the cross section is a size in any direction in a plane in which the cross section is located, for example, a size in a y-axis direction.

When the button 50 is not pressed, an outer surface 53 of the button 50 is flush with an outer surface 23 of the rear cover 20 (as shown in FIG. 7(a)). The outer surface 53 of the button 50 is a surface that is of the button 50 and that is exposed to an outside of the electronic device and can be pressed by the user. In this arrangement, an appearance aesthetic degree of the electronic device is improved.

An elastic material is disposed on an abutting surface (namely, a surface 54) that is of the button 50 and that abuts against the latch 40. This arrangement helps to implement reliable abutting between the latch 40 and the button 50. This is because in some cases, manufacturing errors of the latch 40 and the button 50 (for example, manufacturing errors along the z direction) may exist. In this way, after the middle frame 10 and the rear cover 20 are assembled together, a gap along the z direction may exist between the latch 40 and the button 50. When there is a gap between the latch 40 and the button 50, an initial stage of pressing is actually an idle stroke when the user presses the button 50. In the idle stroke, the button 50 is not in contact with the latch 40, and the user cannot perceive the force feedback from the electronic device. This affects user experience.

Therefore, in this embodiment, the elastic material 56 is disposed on the surface 54 of the button 50. The elastic material 56 may be in a compressed state. The elastic material 56 is disposed, so that an elastic deformation of the elastic material 56 may be used to compensate for the manufacturing errors of the latch 40 and the button 50, to ensure that the latch 40 and the button 50 abut against each other. This improves operation experience of the user. A specific material of the elastic material 56 is not limited in this embodiment. The elastic material 56 may be an elastic rubber, a foam material, a cotton material, or the like.

For example, one or more grooves 55 (two grooves are shown in FIG. 7) are provided on the surface 54 of the button 50, the elastic material 56 is filled in the grooves 55 and is filled along the z direction in a gap that is between the latch 40 and the button 50 and that is in the z direction. This application is not limited thereto. In another embodiment, the elastic material 56 may alternatively be directly disposed on the surface 54.

In this embodiment, the elastic material 56 is disposed on the surface 54 of the button 50. In some other embodiments, the elastic material 56 may alternatively be disposed on an abutting surface (namely, a surface 43) that is of the latch 40 and that abuts against the button 50. For example, a groove may be provided on the surface 43 of the latch 40, and the elastic material 56 is filled in the groove. In some other embodiments, the elastic material 56 may be disposed on both the surface 43 of the latch 40 and the surface 54 of the button 50.

The following describes an example assembling manner of the body 1 of the electronic device provided in this embodiment. An assembling manner provided in this embodiment includes the following steps.
Step 1: Sleeve the spring 60 on the guide post 41 of the latch 40.
Step 2: Install the latch 40 on the middle frame 10 by using a screw, to complete assembling of the middle frame assembly. In this case, the latch 40 is located in the first position, and the spring has the first compression amount.
Step 3: Fill the elastic material 56 in the groove 55 of the button 50. In this embodiment, the elastic material 56 is fastened in the groove 55 in a bonding manner. In another embodiment, the elastic material may alternatively be filled in the groove 55 in an injection molding (for example, insert injection molding or lim injection molding) manner.
Step 4: Install the button 50 on the rear cover 20 to form the rear cover assembly. Specifically, the button body 51 of the button 50 passes through the through hole of the rear cover 20, and the shoulder 52 of the button 50 is in contact with an inner surface (a surface that is of the rear cover 20 and that faces the inner cavity 11) of the rear cover 20, to install the button 50 on the rear cover 20.
Step 5: Use a temporary fastening measure to fasten the button 50 on the rear cover 20. In some embodiments, the button 50 is temporarily fastened on the rear cover 20 in a manner of attaching paper tape (for example, masking tape and release paper tape) on the surface 53 of the button 50 and the surface 23 of the rear cover 20. In some other embodiments, the button 50 is temporarily fastened on the rear cover 20 in a magnetic attraction manner. In this embodiment, at least a part (for example, the button body 51) of the button 50 is made of a magnetic material. In this way, a magnet block is disposed on the outer surface of the rear cover 20, so that the button 50 can be attracted and attached to the rear cover 20. In this embodiment, the magnet block is used as a process equipment in an assembling process, and may be repeatedly used, to reduce production costs.
Step 6: Assemble the middle frame 10 and the rear cover 20 to form the body 1. Specifically, the clamping block 22 of the rear cover 20 is clamped in the clamping slot 12 of the middle frame 10, and a combination surface 15 of the middle frame 10 is bonded to a combination surface 25 of the rear cover 20 by using adhesive (for positions of the combination surface 15 and the combination surface 25, refer to FIG. 7(a)), to complete assembling of the middle frame 10 and the rear cover 20. Then, the middle frame 10 and the rear cover 20 are held in rest under a maintained pressure, to implement firm bonding between the middle frame 10 and the rear cover 20. After the middle frame 10 and the rear cover 20 are assembled together, the temporary fastening measure (for example, release paper tape) of the button 50 and the rear cover 20 may be removed.

The foregoing describes an example assembling method of the electronic device provided in this embodiment. According to the electronic device provided in this embodiment, an assembling solution is simple, management and control difficulty is low, automatic assembling can be implemented, and overall costs are low.

The following describes a connection manner between the wrist strap 2 and the body 1. Refer to FIG. 4. The latch 40 includes a through hole 42 (as a second through hole) extending along the x direction, and the wrist strap 2 includes a latch hook 210. When the latch 40 is located in the first position, the latch hook 210 can pass through the through hole 42 and be hooked, along the x direction, with the latch 40. In this case, the latch 40 may latch the wrist strap 2 to the body 1. When the latch 40 is located in the second position, the latch hook 210 can be detached from the through hole 42. In this case, the latch 40 may release the wrist strap 2 from the body 1.

In some other embodiments, a connection between the wrist strap 2 and the body 1 is implemented in a manner of structure interference. In other words, a combination member A for connecting to the body 1 is disposed on the wrist strap 2, and a combination member B for connecting to the wrist strap 2 is disposed on the body 1. The combination member A and the combination member B may be connected in a mutual interference manner (for example, a squeezing manner), so that the body 1 is connected to the wrist strap 2. In this embodiment, it is relatively difficult for the user to replace the wrist strap 2, and long-term reliability of the structure is poor.

In this embodiment, the latch 40 fits with the latch hook 210, so that the body 1 is connected to the wrist strap 2. This helps the user to remove and install the wrist strap 2 conveniently, and can improve long-term reliability of the structure.

It should be noted that this embodiment is merely an example of a latching manner of the wrist strap 2, and a person skilled in the art may make other variations. For example, in another embodiment, a magnetic attraction structure A is disposed on the latch 40, and a magnetic attraction structure B is disposed at an end that is of the wrist strap 2 and that is combined with the body 1. When the latch 40 is located in the first position, the magnetic attraction structure A and the magnetic attraction structure B are attracted and attached to each other. In this case, the latch 40 may latch the wrist strap 2 to the body 1. When the latch 40 is located in the second position, a magnetic attraction force between the magnetic attraction structure A and the magnetic attraction structure B disappears. In this case, the latch 40 may release the wrist strap 2 from the body 1.

In this embodiment, the middle frame 10 includes a through hole 16 (as a third through hole) extending along the x direction, and the latch hook 210 can pass through the through hole 16 to be hooked with the latch 40. The wrist strap 2 further includes a stopper 220 connected to the latch hook 210, where the stopper 220 is located on an outer side of the middle frame 10. When the latch hook 210 is hooked with the latch 40, the stopper 220 and the middle frame 10 abut, along the x direction, against each other. In this way, the wrist strap 2 may be stably latched to the body 1.

Optionally, an elastic material 240 is disposed on an abutting surface (namely, a surface 230) that is of the stopper 220 and that abuts against the middle frame 10, and this arrangement helps to stably latch the wrist strap 2 to the body 1. This is because, in some cases, as a result of manufacturing/assembling errors of components (for example, errors along the x direction), a gap along the x direction may exist between the stopper 220 and the middle frame 10 after the wrist strap 2 is latched to the body 1. When there is a gap between the stopper 220 and the middle frame 10, the latch hook 210 shakes relative to the latch 40, and the user feels that connection of the wrist strap 2 is unstable.

Therefore, in this embodiment, the elastic material 240 is disposed on the abutting surface (namely, the surface 230) that is of the stopper 220 and that abuts against the middle frame 10. The elastic material 240 may be in a compressed state. The elastic material 240 is disposed, so that an elastic deformation of the elastic material 240 may be used to compensate for the manufacturing/assembling errors of the components, to ensure that the stopper 220 and the middle frame 10 abut against each other. This eliminates shaking of the latch hook 210 relative to the latch 40, and improves user experience.

A specific material of the elastic material 240 may be the same as the material of the elastic material 56, for example, an elastic rubber or a cotton material. For a manner of disposing the elastic material 240 on the surface 230, refer to a manner of disposing the elastic material 56 on the surface 54 of the button 50. For example, a groove 260 is provided on the surface 230, and the elastic material 240 is filled in the groove 260. Details are not described again.

In some other embodiments, the elastic material 240 may alternatively be disposed on an abutting surface (namely, a surface 17) that is of the middle frame 10 and that abuts against the stopper 220. In some other embodiments, the elastic material 240 may be disposed on both the surface 230 and the surface 17.

The following describes working manners of components of the electronic device in a process of removing and installing the wrist strap 2.
(1) For the process of removing the wrist strap 2, refer to FIG. 4(a). When the user presses the button 50, the button 50 pushes the latch 40 to move upward from the first position, and the elastic element 60 is compressed. Refer to FIG. 4(b). When the elastic element 60 moves to the second position, the latch hook 210 can be detached from the through hole 42 of the latch 40. In this case, the user pulls the wrist strap 2, and may remove the wrist strap 2 from the body 1.

After the wrist strap 2 is detached from the body 1, the user stops pressing the button 50. After the pressing force F of the user is released, the latch 40 automatically resets to the first position under an action of the recovery force of the elastic element 60, and simultaneously pushes the button 50 to reset to an initial position (namely, a position shown in FIG. 4(a)).
(2) In the process of installing the wrist strap 2, the user operates the latch hook 210, so that the latch hook 210 passes, along the x direction, through the through hole 16 on the middle frame 10, and the latch hook 210 pushes against the latch 40. Under a pushing action of the latch hook 210 (or under an action of the push force of the button 50), the latch 40 moves upward, and the elastic element 60 is compressed until the latch hook 210 can pass through the through hole 42. After the latch 40 passes through the through hole 42, the latch 40 is reset to the first position under an action of a resetting force of the elastic element 60. In this case, the latch hook 210 can be hooked with the latch 40.

For example, refer to FIG. 4(b). A chamfered surface 270 is disposed on a surface that is of the latch hook 210 and that is used to push against the latch 40, and a chamfered surface 45 is disposed on a surface that is of the latch 40 and that is pushed against by the latch hook 210. In this arrangement, when the latch hook 210 pushes against the latch 40, an upward force is generated on the latch 40, so that the latch 40 can be successfully lifted upward and passes through the through hole 42. In other words, the chamfered surface 270 and the chamfered surface 45 are disposed. This helps the user to successfully install the wrist strap 2 on the body 1.

In conclusion, according to the wrist-worn electronic device provided in this embodiment, the button 50 and the latch 40 are disposed to be independent of each other, so that assembling precision of the button 50 on the rear cover 20 can be ensured. This improves operation convenience and appearance aesthetics of the device, and improves durability of the electronic device.

In addition, compared with a conventional technology in which a connection mechanism of a wrist strap removing and installing mechanism is complex, removing and installing is inconvenient, durability is poor, the electronic device provided in this embodiment has many advantages such as a simple structure design, stable connection between components, good durability and a convenient wrist strap removing and installing process.

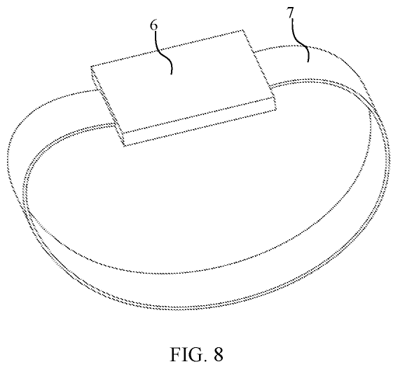

Refer to FIG. 8. In another embodiment of this application, a wearable device is further provided. The wearable device may be an electronic device, or may be a non-electronic device. The wearable device includes a body 6 and a strap 7, and the strap 7 is used to wear the body 6 on a human body. A wearing manner of the wearable device is not limited in this embodiment. For example, the wearable device may be worn on a wrist, an arm, an ankle, a waist, a head, a neck, or the like of the user. The body 6 may be connected to only one end of the strap 7, or may be separately connected to two ends of the strap 7.

The body 6 includes a middle frame, a rear cover, a latch, and a button that are independent of each other in structure. An inner cavity is formed in the middle frame. The rear cover covers, along a first direction, the middle frame, the rear cover includes a first through hole extending along the first direction, and the first through hole communicates with the inner cavity of the middle frame. The latch is disposed in the inner cavity of the middle frame, and can move, along the first direction relative to the middle frame, between a first position and a second position. When the latch is located in the first position, at least one end of the strap 7 can be latched to the body 6, or when the latch is located in the second position, at least one end of the strap 7 can be released from the body 6. The button extends through the first through hole and abuts, along the first direction, against the latch, where the button is used to provide, when being pressed, the latch with a push force for moving from the first position to the second position.

In other words, a manner of disposing the middle frame, the rear cover, the latch, and the button in the body 6 is substantially the same as the manner of disposing the middle frame 10, the rear cover 20, the latch 40, and the button 50 in the foregoing, and a manner of disposing the strap 7 is substantially the same as the manner of disposing the wrist strap 2 in the foregoing. For details and technical effects that are not described above, refer to the foregoing descriptions about the middle frame 10, the rear cover 20, the latch 40, the button 50, and the wrist strap 2. Details are not described again.

In the foregoing descriptions of this embodiment, unless otherwise specified, “/” means “or”. For example, A/B may represent A or B. “and/or” in this specification describes only an association relationship between associated objects and represents that three relationships may exist. For example, A and/or B may represent the following three cases: Only A exists, only B exists, and both A and B exist. In addition, in this embodiment, values of each data range include a boundary value. For example, A=10 to 50 indicates that A may be 10 or 50.

1. A wearable device, comprising a body and a strap, wherein the body comprises a middle frame, a rear cover, a latch, and a button that are independent of each other in structure, and wherein:
an inner cavity is formed in the middle frame;
the rear cover covers, along a first direction, the middle frame, the rear cover comprises a first through hole extending along the first direction, and the first through hole connects with the inner cavity of the middle frame;
the latch is disposed in the inner cavity of the middle frame, and is configured to move, along the first direction relative to the middle frame, between a first position and a second position, wherein when the latch is located in the first position, at least one end of the strap is latched to the body, or when the latch is located in the second position, at least one end of the strap is released from the body; and
the button extends through the first through hole and abuts, along the first direction, against the latch, wherein the button is used to provide, when being pressed, the latch with a push force for moving from the first position to the second position.

2. The wearable device according to claim 1, wherein at least one of:
an elastic material is disposed on an abutting surface that is of the button and that abuts against the latch; or
an elastic material is disposed on an abutting surface that is of the latch and that abuts against the button.

3. The wearable device according to claim 2, wherein at least one of:
a groove is provided on the abutting surface that is of the button and that abuts against the latch; or
a groove is provided on the abutting surface that is of the latch and that abuts against the button; and
wherein the elastic material is disposed in the groove, and the elastic material is used to fill, in the first direction, a gap between the button and the latch.

4. The wearable device according to claim 1, wherein the button comprises a button body and a shoulder that are connected along the first direction, the button body is located in the first through hole, the shoulder is located in the inner cavity, and a size of a cross section of the shoulder is greater than a size of a cross section of the first through hole.

5. The wearable device according to claim 1, wherein when the button is not pressed, an outer surface of the button is flush with an outer surface of the rear cover.

6. The wearable device according to claim 1, wherein at least a part of the button is made of a magnetic material.

7. The wearable device according to claim 1, wherein the latch and the middle frame are connected by using an elastic element, and the elastic element is used to provide the latch with a recovery force for returning from the second position to the first position.

8. The wearable device according to claim 7, wherein along the first direction, the elastic element is located on a side that is of the latch and that faces away from the button.

9. The wearable device according to claim 7, wherein when the latch is in the first position, the elastic element has a first compression amount, or when the latch is in the second position, the elastic element has a second compression amount, and wherein the second compression amount is greater than the first compression amount.

10. The wearable device according to claim 7, wherein the elastic element is a spring, and the latch comprises a guide post sleeved in the spring.

11. The wearable device according to claim 1, wherein the middle frame comprises a limiting part, and the limiting part is used to limit a limit movement position of an end of the latch in the first direction to the first position.

12. The wearable device according to claim 1, wherein the latch comprises a second through hole extending along a second direction, and the second direction is perpendicular to the first direction; and
wherein the strap comprises a latch hook, and wherein:
when the latch is located in the first position, the latch hook is configured to pass through the second through hole and be hooked, along the second direction, with the latch to latch the strap to the body; or
when the latch is located in the second position, the latch hook is configured to be detached from the second through hole to release the strap from the body.

13. The wearable device according to claim 12, wherein the middle frame comprises a third through hole extending along the second direction, and the latch hook is configured to pass through the third through hole to be hooked with the latch; and
wherein the strap further comprises a stopper connected to the latch hook, the stopper is on an outer side of the middle frame, and when the latch hook is hooked with the latch, the stopper and the middle frame abut, along the second direction, against each other, wherein at least one of:
an elastic material is disposed on an abutting surface that is of the stopper and that abuts against the middle frame; or
an elastic material is disposed on an abutting surface that is of the middle frame and that abuts against the stopper.

14. The wearable device according to claim 1, wherein a clamping slot is disposed on one of the middle frame and the rear cover, a clamping block is disposed on the other one of the middle frame and the rear cover, and along the first direction, the clamping block is clamped in the clamping slot, so that the rear cover covers, along the first direction, the middle frame.

15. (canceled)

16. The wearable device according to claim 1, wherein the wearable device is a wrist-worn device, and the strap is a wrist strap.

17. The wearable device according to claim 8, wherein the elastic element is a spring, and the latch comprises a guide post sleeved in the spring.

18. The wearable device according to claim 9, wherein the elastic element is a spring, and the latch comprises a guide post sleeved in the spring.

19. The wearable device according to claim 1, wherein an elastic material is disposed on an abutting surface that is of the button and that abuts against the latch.

20. The wearable device according to claim 1, wherein an elastic material is disposed on an abutting surface that is of the latch and that abuts against the button.

21. The wearable device according to claim 1, wherein an elastic material is disposed on an abutting surface that is of the button and that abuts against the latch, and an elastic material is disposed on an abutting surface that is of the latch and that abuts against the button.
